(19) United States
(12) Patent Application Publication
(10) Pub. No.: US 2011/0078712 A1
(43) Pub. Date: Mar. 31, 2011

(54) SPINDLE MOTOR AND INFORMATION STORAGE DEVICE INCLUDING THE SAME

(76) Inventors: Euihyun Kim, Suwon-si (KR); Jeonggoo Kim, Gunpo-si (KR); Youngbok Yu, Seoul (KR)

(21) Appl. No.: 12/995,246

(22) PCT Filed: Dec. 2, 2009
(86) PCT No.: PCT/KR2009/007140

§ 371 Date: Nov. 30, 2010

(30) Foreign Application Priority Data
Jan. 30, 2009 (KR) 1020090007411

(51) Int. Cl. G11B 17/028

(52) U.S. Cl. 720/710; G9B/17.006

(57) ABSTRACT

A spindle motor for an optical disc drive complements a loss of a function of automatically correcting a center of the spindle motor that may occur due to an excessive centrifugal force of an optical disc that is generated as the rotation speed of the spindle motor is increased. A conic outer circumferential surface of a slide cone closely contacts an inner circumferential surface of the optical disc so that a center of the optical disc is the same as a rotational center of the spindle motor The slide cone is cup-shaped so that the slide cone vertically slides in the direction of the rotation shaft. A cone yoke exerts a force to push the slide cone upwards in an axial direction so that an attractive force is used between the yoke and a magnetic cone yoke or an attractive force between the magnetic cone yoke and a clamp magnet.

### CROSS-REFERENCE TO RELATED APPLICATIONS

This application is a National Stage of PCT International Patent Application No. PCT/KR2009/007140, filed Dec. 2, 2009, and claims the benefit of Korean Patent Application No. 10-2009-0007411, filed Jan. 30, 2009 in the Korean Intellectual Property Office, the disclosures of which are incorporated herein by reference.

### BACKGROUND OF THE INVENTION

1. Field of the Invention

Aspects of the present invention relate to a spindle motor on which an information storage medium having a central opening portion can be easily installed or detached and a center of the information storage medium can be automatically aligned with a rotational center of the spindle motor, and to a rotational information storage device including the spindle motor.

2. Description of the Related Art

In recent years, an optical disc such as a CD or a DVD clearly tends to increase its rotational speed of the optical disc. As the rotation speed of such an optical disc is increased, the centrifugal force of the optical disc excessively increases for various reasons. Thus, when the optical disc is installed at a driving motor, a correction device that allows a rotational center of the spindle motor and a rotational center of the optical disc to be identical with each other has been developed.

In a rotational information storage device at which or from which an optical disc is installed or detached, such as an optical disc drive, a spindle motor rotates the optical disc to be used as an information storage medium. In an optical disc having a central opening portion, a bottom surface of the optical disc is mounted on a turntable disposed above the spindle motor, and the central opening portion thereof is inserted in a protrusion formed in the middle of the turntable and the optical disc is rotated along with the spindle motor. However, In mass production of optical discs made of a flexible material, such as plastic. It is difficult to keep the dimension of an inner hole of the optical disc uniform. Thus, when optical discs that are manufactured on a mass scale are installed at the spindle motor, a gap between an inner circumferential surface of the central opening portion of the optical disc and the protrusion of the turntable occurs.

When a gap between the inner hole of the optical disc and the protrusion of the turntable occurs, the rotational center of the optical disc is not identical with the rotational center of the spindle motor. As such, errors occur when data is written on the optical disc and/or read from the optical disc.

In order to solve the problem, a conventional spindle motor is shown in FIG. 8.

In the conventional spindle motor of FIG. 8, a plurality of hook-shaped claws 2b are formed at an outer circumferential surface of a protrusion 2a of a turntable 2 that comes in contact with an inner circumferential surface 1a of a central opening portion of an optical disc 1. As indicated in FIG. 8, it is an elastic member that the hookshaped claws 2b formed at the outer circumferential surface of the protrusion 2a of the turntable 2. The size of each of the claws 2b is greater than the size of an inner hole of the optical disc 1 and each of the claws 2b has the form of a hook. Thus, when the optical disc 1 is inserted in the protrusion 2a of the turntable 2, the hook-shaped claws 2b are pressed to a center of a rotation shaft and come in contact with the inner circumferential surface 1a of the central opening portion of the optical disc 1. In this case, due to an elastic force that the hook-shaped claws 2b are restored to their original shape, an outer circumferential surface of the central opening portion of the optical disc 1 is pushed from a rotational center of the optical disc 1 to the outside so as to retain the optical disc 1 while an equilibrium between the retaining force and the centrifugal force imposed on the optical disc 1 has been maintained. As such, the claws 2b allow the outer circumferential surface of the central opening portion of the optical disc 1 to be pushed out of a radial direction and as a result, the rotational center of the optical disc 1 may be identical with the rotational center of the spindle motor.

However, the optical disc 1 is generally formed of a flexible material such as plastics and thus damage, deformation or wear may occur when the optical disc 1 is manufactured, handled or kept. When damage, deformation or wear occurs in the optical disc 1, a center of mass of the optical disc 1 deviates from the rotational center of the optical disc 1. When the center of mass of the optical disc 1 deviates from the rotational center of the optical disc 1 and the spindle motor rotates at high speed, a centrifugal force is greatly increased, and the centrifugal force is greater than elasticity or a restoration force of the claws 2b formed at the outer circumferential surface of the protrusion 2a of the turntable 2. Thus, the rotational center of the optical disc 1 deviates from the rotational center of the spindle motor.

When the center of the optical disc 1 deviates from the rotational center of the spindle motor, data written in the optical disc 1 may not be read, or data may not be written in a designated position of the optical disc 1. In other words, when the centrifugal force of the optical disc 1 is weak, any special problem does not occur. However, when the centrifugal force of the optical disc 1 is excessive, the optical disc 1 does not operate normally.

In order to overcome the problem, the elasticity of the claws 2b may be sufficiently increased. In this case, the inner hole of the optical disc 1 is strongly fixed at the protrusion 2a of the turntable 2 so that the optical disc 1 may not be smoothly replaced with a new one. Due to the drawback, it is difficult to store and reproduce information according to an optical disc while replacing the optical disc with a new one.

### SUMMARY OF THE INVENTION

Accordingly, An object of the present invention is to provide a spindle motor in which an operation of replacing an optical disc is smoothly performed and of which a center is automatically adjusted so that a slide cone may come in contact with a central opening portion of the optical disc, a rotational center of the optical disc may be substantially identical with a rotational center of the spindle motor even under a strong centrifugal force of the optical disc.

Another object of the present invention is to provide a spindle motor which starts rotating while an information storage medium is not slid.

Another object of the present invention is to provide a spindle motor that includes a small rotor portion and a turntable at which a relatively large optical disc is installed.

Another object of the present invention is to provide an information storage device which is not affected by an increase in the centrifugal force of an optical disc and uses a spindle motor that is easily installed or detached at or from the optical disc so that information may be stably written or reproduced in or from the optical disc.

To achieve these and other advantages and in accordance with the purpose of the present invention, as embodied and broadly described, there is provided a spindle motor at which or from which an information storage medium having a central opening portion is installed or detached, for rotating the information storage medium, the spindle motor including: a rotation shaft; a slide cone of a substantially cup-like shape comprising a cone cylindrical portion of a substantially cylindrical shape having an outer circumferential surface that may contact an inner circumferential portion of the central opening portion of the information storage medium, a cone bottom portion in which the rotation shaft is inserted so that the cone is movable in an axial direction with respect to the rotation shaft, and a hollow portion formed upwards by the cone cylindrical portion and the cone bottom portion; a turntable of a substantially hat-like shape comprising a turntable cylindrical portion of a substantially cylindrical shape having a top surface extended outward of the turntable cylindrical portion making contact with a bottom surface of the information storage medium, a turntable bottom portion in which the rotation shaft is inserted so that the spindle motor rotates along with the rotation shaft, and a hollow portion in which, when the slide cone goes down in an axial direction, the slide cone is accommodated by the turntable cylindrical portion and the turntable bottom portion; a yoke fixed at upper portions of the rotation shaft that protrudes from the slide cone within the hollow portion of the slide cone; a clamp magnet disposed on the yoke; and a cone yoke fixed at the cone bottom portion so that the cone yoke makes an axial motion in a direction below the yoke together with the slide cone and formed of a magnetic material.

Also, the cone yoke may be fixed at a top surface or a bottom surface of the cone bottom portion of the slide cone. Furthermore the cone yoke may be a permanent magnet.

Also, the spindle motor may further include a rubber plate that is substantially attached to the top surface of the cylindrical portion of the turntable so that, when the information storage medium is mounted on the spindle motor, the bottom surface of the information storage medium directly contacts the rubber plate.

Also, the spindle motor may further include a rotor magnet; and a rotor case rotating along with the rotation shaft and comprising a cylindrical portion at which the rotor magnet is installed, wherein an outer circumferential surface of the cylindrical portion of the rotor case is placed in an inner position than a position of a cylindrical outer circumferential surface of the top surface of the cylindrical portion of the turntable in a radial direction.

According to another aspect of the preset invention, there is provided an information storage device including: the spindle motor described above; a pickup unit comprising an information writing portion for writing information in an information storage medium and an information reading portion for sensing the information from the information storage medium; a controller controlling a motion of the pickup unit; and a signal converter converting a signal transmitted from the pickup unit into a predetermined signal.

As described above, in the spindle motor according to the present invention, the center of an optical disc does not deviate from the rotational center of the spindle motor even during high-speed rotation but is identical therewith so that, in an optical disc drive rotating at high speed, errors that may occur in writing or reading data in or from the optical disc can be reduced and the optical disc can be easily replaced with a new one. Furthermore, when the spindle motor starts rotating, a robust rotational force of a storage medium may be exerted by friction between a rubber plate and a storage medium so that sliding during rotation can be prevented.

Furthermore, an additional elastic member that pushes a slide cone is not even used, but, the slide cone is moved upwards due to an attractive force between a yoke and a cone yoke that is a magnet or an attractive force between the cone yoke that is formed of a magnetic material and a clamp magnet so that the storage medium be retained on the turntable and a slim spindle motor can be provided and the productivity and assembling characteristics of the spindle motor can be improved.

Furthermore, the spindle motor including a smaller rotor portion can be employed in the optical disc drive.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial cross-sectional view of a spindle motor before an optical disc is mounted on the spindle motor, according to an embodiment of the present invention;

FIG. 2 is a partial cross-sectional view of the spindle motor of FIG. 1 after the optical disc is mounted on the spindle motor of FIG. 1;

FIG. 3 is a partial cross-sectional view of a spindle motor before an optical disc is mounted on the spindle motor, according to another embodiment of the present invention;

FIG. 4 is a partial cross-sectional view of the spindle motor of FIG. 3 after the optical disc is mounted on the spindle motor of FIG. 3;

FIG. 5 is a partial cross-sectional view of a spindle motor before an optical disc is mounted on the spindle motor, according to another embodiment of the present invention;

FIG. 6 is a partial cross-sectional view of the spindle motor of FIG. 5 after the optical disc is mounted on the spindle motor of FIG. 5;

FIG. 7 is a cross-sectional view of an optical disc drive in which the optical disc of FIG. 1, 3 or 5 is used; and

FIG. 8 is a partial cross-sectional view of a conventional spindle motor.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The above and other aspects of the present invention will become more apparent by describing in detail exemplary embodiments thereof with reference to the attached drawings.

The terminology or term used in the present specification and the claims should not be construed as limited to general or dictionary's definitions. The terminology or term used herein should be construed to meet the technical spirit of the invention on the basis of the concept of the terminology appropriately defined in order to describe the inventor(s)' invention in the best manner.

Detailed illustrative example embodiments are disclosed herein. However, specific structural and functional details disclosed herein are merely representative for purposes of describing example embodiments. This invention may, however, may be embodied in many alternate forms and should not be construed as limited to only the example embodiments set forth herein.

It will be understood that the terms “above”, “below”, “under”, “on”, “left”, “right”, “inner”, and “outer” may be used herein to describe the relative position or direction between various elements or parts and the relative position or direction in the drawings.

Hereinafter, the present invention will be described in detail by explaining exemplary embodiments of the invention with reference to the attached drawings.

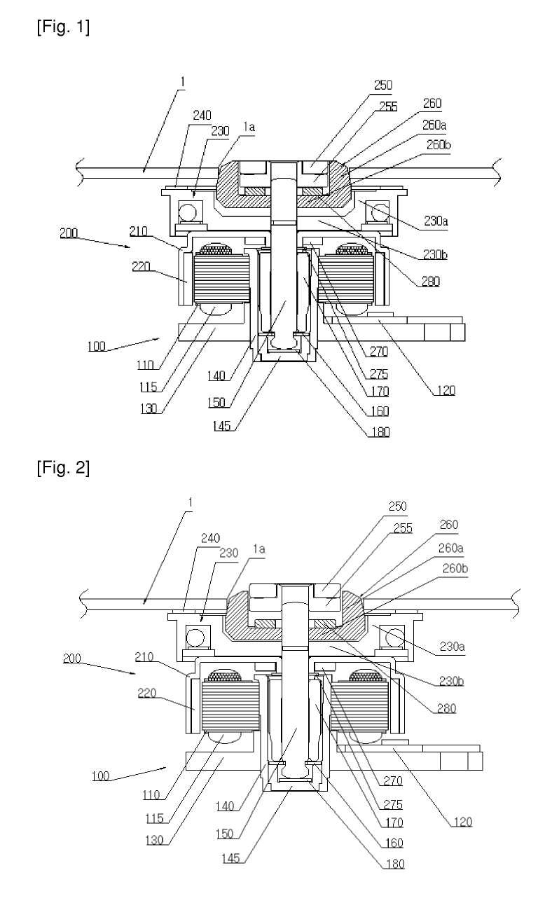

FIG. 1 is a partial cross-sectional view of a spindle motor before an optical disc is mounted on the spindle motor, according to an embodiment of the present invention, and FIG. 2 is a partial cross-sectional view of the spindle motor of FIG. 1 after the optical disc is mounted on the spindle motor of FIG. 1. In the present embodiment, a cone yoke that will be described later is a magnet fixed at a top surface of a bottom portion of a slide cone.

As illustrated in FIGS. 1 and 2, the spindle motor includes a stator portion 100 that is fixed at an optical disc drive and a rotor portion 200 that rotates along with a rotation shaft 150.

First, the stator portion 100 includes a core 110, a coil 115, a circuit board 120, a bracket 130, a bearing housing 140, a cap 145, the rotation shaft 150, a washer 160, a sliding bearing 170, and a thrust plate 180, which are sequentially assembled. In detail, the rotation shaft 150 is inserted in the sliding bearing 170 and rotates therein, and the sliding bearing 170 is disposed in the bearing housing 140 and is fixed therein. The bearing housing 140 is cylindrical, and a stator is disposed at an outer circumferential surface of the bearing housing 140. The stator generally includes a plurality of cores 110 and the coil 115 that surrounds the cores 110. The cap 145 is inserted from a top of the cylindrical bearing housing 140 into an opening formed in lower portions of the cylindrical bearing housing 140, or the bearing housing 140 is formed as one body in a cup shape (not shown) and the sliding bearing 170 in which the rotation shaft 150 is inserted may be placed in the bearing housing 140. In case of using the cap 145, the washer 160 is disposed above a top surface of a cylindrical wall of the cap 145. In case of using the cup shape bearing housing 140, a cylindrical wall surface of the lower portions of the bearing housing 140 is formed as stepped surfaces so that the washer 160 may be disposed on the stepped surfaces. The washer 160 may be inserted in a small diameter portion of the rotation shaft 150. The sliding bearing 170 is a porous metal-containing bearing. Lowest bottom ends of the cylindrical sliding bearing 170 contact the top surface of the washer 160, and the cylindrical sliding bearing 170 is inserted in the bearing housing 140 so that an outer circumferential surface of the cylindrical sliding bearing 170 may contact an inner circumferential surface of the bearing housing 140. The thrust plate 180 is disposed on the cap 145 or on the bottom surface of the cup shape bearing housing 140 so that the thrust plate 180 may contact the lowest bottom ends of the rotation shaft 150. The bearing housing 140 is inserted in a cylindrical protrusion of the bracket 130 and is fixed therein. An outer circumferential surface of a top end of the protrusion is disposed to support the cores 110, and the circuit board 120 is disposed on the top surface of the bracket 130 below the cores 110.

Secondly, the rotor portion 200 includes a rotor case 210, a rotor magnet 220, a turntable 230, a rubber plate 240, a clamp magnet 250, a slide cone 260, a thrust magnet 270, a washer 275, and a rotation shaft 150, which are sequentially assembled. In detail, the rotor case 210 is substantially cylindrical, and the rotor magnet 220 of a cylindrical shape that faces the stator 190 is attached to an inner circumferential surface of the cylindrical rotor case 210. The rotation shaft 150 is inserted in a cylindrical portion of a center of the rotor case 210 above upper portions of the sliding bearing 170 and the rotation shaft 150 is fixed at an inner circumferential surface of the cylindrical portion of the center of the rotor case 210 so that the rotor case 210 and the rotor magnet 220 may rotate along with the rotation shaft 150. The thrust magnet 270 is disposed at an outer circumferential surface of the cylindrical portion of the center of the rotor case 210 fixed at the rotation shaft 150, and the washer 275 is disposed in an opening formed in a bottom end of the cylindrical portion of the center of rotor case 210.

The turntable 230 having a substantially hat-like shape is disposed on the rotor case 210 so that the turntable 230 may rotate along with the rotation shaft 150, and an optical disc 1 that is an information storage medium is disposed on the top surface of a cylindrical portion 230a of the turntable 230. A bottom portion 230b in which the rotation shaft 150 is perforated and is fixed is formed in the cylindrical portion 230a of the turntable 230, and a hollow portion in which the slide cone 260 may be placed is formed by the cylindrical portion 230a and the bottom portion 230b. In this case, in order to use a variety of small motors, the outer circumferential surface of the cylindrical portion of the rotor case 210 may be placed in an inner position than the position of a cylindrical outer circumferential surface of an optical disc mounting portion 230b in a radial direction.

The slide cone 260 is substantially cup-shaped. When the optical disc 1 is installed at the spindle motor, an outer circumferential surface of a cylindrical portion 260a of the slide cone 260 closely contacts the inner circumferential portion 1a of the opening portion of the optical disc 1, and the rotation shaft 150 is perforated in a bottom portion 260b of the slide cone 260 so that the slide cone 260 may slide along the rotation shaft 150 in an axial direction.

In the present embodiment, a hollow cone yoke 280 is fixed at the hollow portion of the slide cone 260 and on the top surface of the bottom portion 260b of the slide cone 260, and the rotation shaft 150 is perforated in a hollow surface of the cone yoke 280 so that the rotation shaft 150 may be vertically slid. Thus, the cone yoke 280 may be vertically slid in an axial direction together with the slide cone 260. In the present embodiment, the rotation shaft 150 is disposed on a top end of a yoke 255 in which the clamp magnet 250 is inserted in the rotation shaft 150, and the cone yoke 280 is placed below the yoke 255.

Also, the rubber plate 240 is substantially attached to the top surface of the optical disc mounting portion 230b so that the bottom surface of the optical disc 1 may directly contact the rubber plate 240 and the optical disc 1 may rotate without sliding when a motor is rotated.

FIG. 1 illustrates the spindle motor before the optical disc 1 is mounted on the turntable 230, according to an embodiment of the present invention. Referring to FIG. 1, a component that allows the optical disc 1 to be mounted on the turntable 230 and to be retained therein is the slide cone 260, the turntable 230, the clamp magnet 250, and a disc clamp (not shown). An outside of the cylindrical portion 260a of the slide cone 260 is usually formed in a cone shape and closely contacts the inner circumferential surface 1a of the opening portion of the optical disc 1, and the clamp magnet 250 and the yoke 255 formed of metal are disposed in the opening portion of the optical disc 1, and the cone yoke 280 is fixed at the top surface of the bottom portion 260b of the slide cone 260 so that the cone yoke 280 may make a vertical motion with respect to the rotation shaft 150 together with the slide cone 260. In the present embodiment, the cone yoke 280 is formed using a magnet. Thus, an attractive force occurs between the cone yoke 280 formed of magnet movable in an axial direction with respect to the rotation shaft and the yoke 255 formed of metal that is disposed in upper portions of the spindle motor and is fixed at the rotation shaft 150 so that the attractive force may exert to push the slide cone 260 upwards. As such, the inner circumferential surface 1a of the opening portion of the optical disc 1 and a conic outer circumferential surface of the slide cone 260 may be kept in a closely contact state.

FIG. 2 illustrates the spindle motor after the optical disc 1 is mounted on the turntable 230, according to an embodiment of the present invention. When a disc clamp (not shown) operates, metal is formed in the center of the disc clamp installed in an optical device, and due to a magnetic force of the clamp magnet 250, the disc clamp is fixed on the clamp magnet, and the disc clamp pushes the optical disc 1 and the slide cone 260 which the optical disc 1 closely contacts downward in the axial direction, and the bottom surface of the optical disc 1 is placed on the top surface of the rubber plate 240 disposed above the turntable 230. When the spindle motor starts rotating, the optical disc 1 rotates due to a frictional force between the spindle motor and the rubber plate 240. Even when a center of mass of the optical disc 1 is not identical with the rotational center of the spindle motor, the inner hole of the optical disc 1 closely contacts the conic outer circumferential surface of the slide cone 260 so that the center of the optical disc 1 may not deviate from the rotational center of the spindle motor and may be identical therewith.

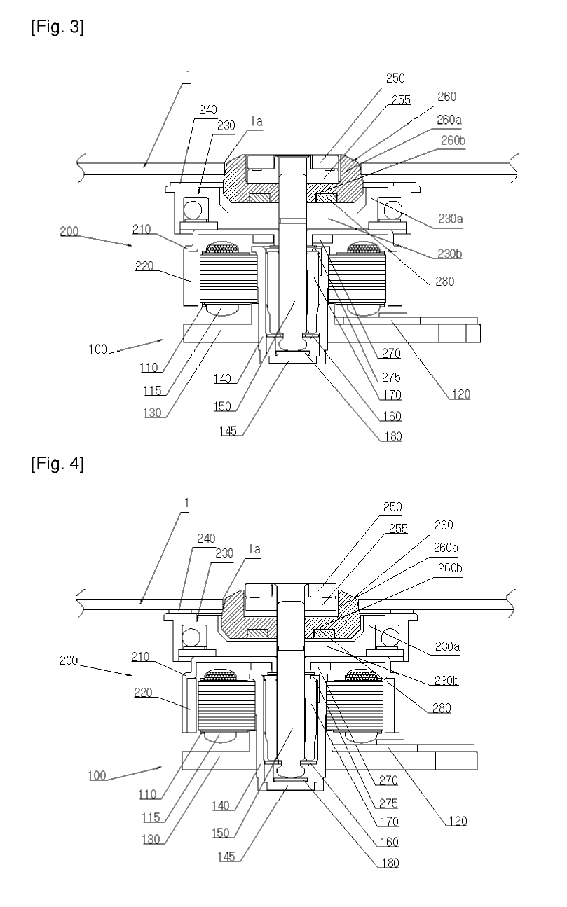

FIG. 3 is a partial cross-sectional view of a spindle motor before an optical disc is mounted on the spindle motor, according to another embodiment of the present invention, and FIG. 4 is a partial cross-sectional view of the spindle motor of FIG. 3 after the optical disc is mounted on the spindle motor of FIG. 3. The only difference between FIGS. 3 and 4 and FIGS. 1 and 2 is that the cone yoke 280 that is a magnet is fixedly installed at a bottom surface of the bottom portion 260b of the slide cone 260, and the other configuration of the spindle motor of FIGS. 3 and 4 is the same as that of the spindle motor illustrated in FIGS. 1 and 2. Thus, the cone yoke 280 is fixed at the bottom surface of the bottom portion 260b of the slide cone 260, and the cone yoke 280 makes a vertical motion with respect to the rotation shaft 150 together with the slide cone 260. Thus, as in FIGS. 1 and 2, due to a magnetic force of the cone yoke 280, an attractive force occurs between the cone yoke 280 formed of magnet movable in an axial direction with respect to the rotation shaft and the yoke 255 that is disposed in upper portions of the spindle motor and is fixed at the rotation shaft 150 and is formed of metal so that a force may exert to push the slide cone 260 upwards. As such, the inner circumferential surface 1a of the opening portion of the optical disc 1 and the conic outer circumferential surface of the slide cone 260 may be kept in a closely contact state.

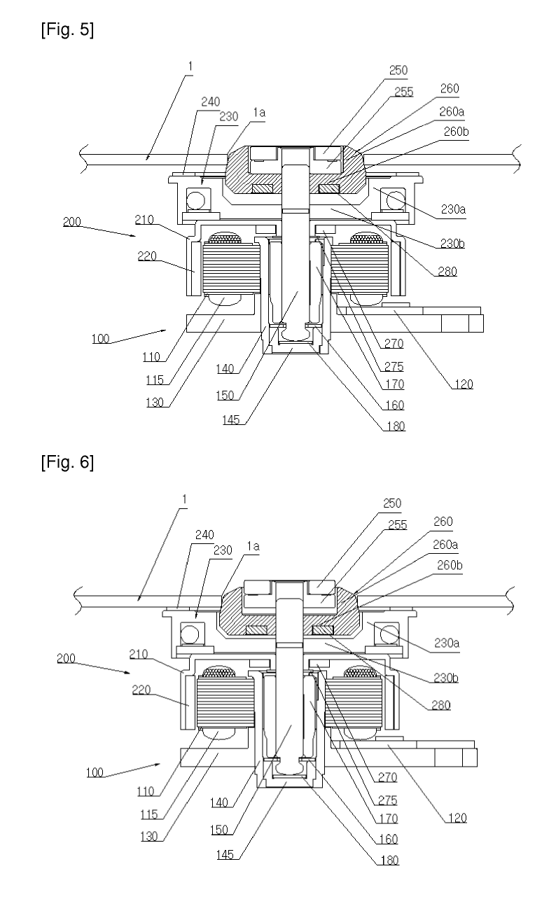

FIG. 5 is a partial cross-sectional view of a spindle motor before an optical disc is mounted on the spindle motor, according to another embodiment of the present invention, and FIG. 6 is a partial cross-sectional view of the spindle motor of FIG. 5 after the optical disc is mounted on the spindle motor of FIG. 5. The only difference between FIGS. 5 and 6 and FIGS. 3 and 4 is that the cone yoke 280 is not a magnet but is formed of a magnetic material as like ferromagnetic substances, and the other configuration of the spindle motor of FIGS. 5 and 6 is the same as that of the spindle motor illustrated in FIGS. 3 and 4.

The magnetic material is material that is attached to a magnet and includes a magnet. However, in the present embodiment, the cone yoke 280 is formed of a general magnetic material such as iron that is not a slightly high-priced magnet so that costs may be reduced. Also, an interference with other element that may unexpectedly occur due to the force of a magnet may be prevented.

In the present embodiment, the cone yoke 280 is fixed at the bottom surface of the bottom portion 260b of the slide cone 260, and the cone yoke 280 makes a vertical motion with respect to the rotation shaft 150 together with the slide cone 260. However, the cone yoke 280 may be fixedly installed at the top surface of the bottom the conic outer circumferential surface of the slide cone 260 so that the center of the optical disc 1 may not deviate from the rotational center of the spindle motor and may be identical therewith.

FIG. 3 is a partial cross-sectional view of a spindle motor before an optical disc is mounted on the spindle motor, according to another embodiment of the present invention, and FIG. 4 is a partial cross-sectional view of the spindle motor of FIG. 3 after the optical disc is mounted on the spindle motor of FIG. 3. The only difference between FIGS. 3 and 4 and FIGS. 1 and 2 is that the cone yoke 280 that is a magnet is fixedly installed at a bottom surface of the bottom portion 260b of the slide cone 260, and the other configuration of the spindle motor of FIGS. 3 and 4 is the same as that of the spindle motor illustrated in FIGS. 1 and 2. Thus, the cone yoke 280 is fixed at the bottom surface of the bottom portion 260b of the slide cone 260, and the cone yoke 280 makes a vertical motion with respect to the rotation shaft 150 together with the slide cone 260. Thus, as in FIGS. 1 and 2, due to a magnetic force of the cone yoke 280, an attractive force occurs between the cone yoke 280 formed of magnet movable in an axial direction with respect to the rotation shaft and the yoke 255 that is disposed in upper portions of the spindle motor and is fixed at the rotation shaft 150 and is formed of metal so that a force may exert to push the slide cone 260 upwards. As such, the inner circumferential surface 1a of the opening portion of the optical disc 1 and the conic outer circumferential surface of the slide cone 260 may be kept in a closely contact state.

FIG. 5 is a partial cross-sectional view of a spindle motor before an optical disc is mounted on the spindle motor, according to another embodiment of the present invention, and FIG. 6 is a partial cross-sectional view of the spindle motor of FIG. 5 after the optical disc is mounted on the spindle motor of FIG. 5. The only difference between FIGS. 5 and 6 and FIGS. 3 and 4 is that the cone yoke 280 is not a magnet but is formed of a magnetic material as like ferromagnetic substances, and the other configuration of the spindle motor of FIGS. 5 and 6 is the same as that of the spindle motor illustrated in FIGS. 3 and 4.

The magnetic material is material that is attached to a magnet and includes a magnet. However, in the present embodiment, the cone yoke 280 is formed of a general magnetic material such as iron that is not a slightly high-priced magnet so that costs may be reduced. Also, an interference with other element that may unexpectedly occur due to the force of a magnet may be prevented.

In the present embodiment, the cone yoke 280 is fixed at the bottom surface of the bottom portion 260b of the slide cone 260, and the cone yoke 280 makes a vertical motion with respect to the rotation shaft 150 together with the slide cone 260. However, the cone yoke 280 may be fixedly installed at the top surface of the bottom portion 260b of the slide cone 260. In this case, the cone yoke 280 is formed of material that may be attached to a magnet, such as iron, i.e., a magnetic material so that, due to the magnetic force of the clamp magnet 250 disposed in upper portions of the spindle motor and fixed at the rotation shaft 150, a force may exert to push the slide cone 260 upwards. As such, the inner circumferential surface 1a of the opening portion of the optical disc 1 and the conic outer circumferential surface of the slide cone 260 may be kept in a closely contact state.

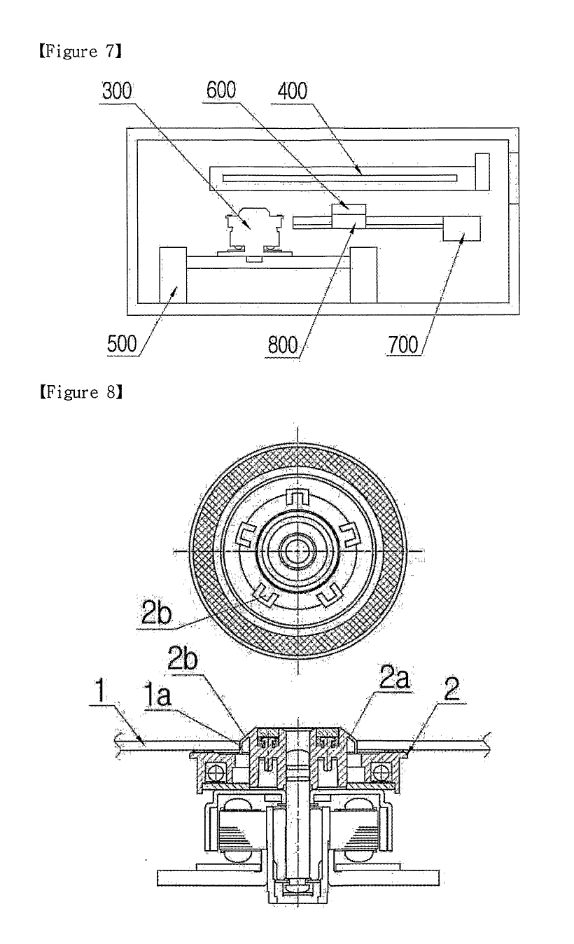

FIG. 7 is a cross-sectional view of an optical disc drive in which the optical disc of FIG. 1, 3 or 5 is used. Referring to FIG. 7, the optical disc drive according to the present embodiment includes a spindle motor 300 illustrated in FIGS. 1 through 6, a tray 400 that carries out the optical disc 1 into the optical disc drive, a driving unit 500 that pulls the spindle motor 300 upwards, an optical pickup unit 600 that writes information in the optical disc 1 or reads the information from the optical disc 1, a controller 700 that controls the motion of the optical pickup unit 600, and a signal converter 800 that converts a signal transmitted from the optical pickup unit 600 into a predetermined signal.

Referring to FIG. 7, the tray 400 that may protrude from the optical disc drive carries out the optical disc 1 into the optical disc drive. When the optical disc 1 is put on the tray 400 and power is supplied to the optical disc drive, the tray 400 is slid into the optical disc drive and is entered into a designated position of the optical disc drive.

When the tray 400 is entered into the designated position of the optical disc drive, the spindle motor 300 moves upwards, and the conic outer circumferential surface of the slide cone 260 of the spindle motor 300 closely contacts the inner hole of the optical disc 1, and the optical disc 1 is pulled upwards by the tray 400 and is separated from the tray 400. After the optical disc 1 is separated from the tray 400, the disc clamp (not shown) installed in the optical disc drive closely contacts the clamp magnet 250 of the spindle motor 300 due to a magnetic force of the clamp magnet 250. In this case, the disc clamp is pushed downwards, and the bottom surface of the optical disc 1 closely contacts the top surface of the annular rubber plate 240 attached to the turntable 230. In other words, the top surface of the optical disc 1 closely contacts the disc clamp, and the disc clamp closely contacts the clamp magnet 250 and is fixed at the spindle motor 300.

As the disc clamp operates, the optical disc 1 closely contacts the top surface of the annular rubber plate 240 disposed on the turntable 230, and the optical disc 1 and the slide cone 260 are pushed downwards and go down. In this case, due to an attractive force between a yoke and a cone yoke that is a magnet or an attractive force between the cone yoke that is formed of a magnetic material and the clamp magnet 250, the slide cone 260 is moved upwards. As such, the inner hole of the optical disc 1 is kept to closely contact the conic outer circumferential surface of the slide cone 260. When power is supplied to the spindle motor 300, the spindle motor 300 starts rotating. In this case, the optical disc 1 mounted on the turntable 230 of the spindle motor 300 closely contacts the slide cone 260 and the disc clamp and rotates together with the spindle motor 300. When the center of mass of the optical disc 1 is not identical with the rotational center of the spindle motor 300, the rotation speed of the spindle motor 300 is increased, and the centrifugal force of the optical disc 1 is rapidly increased. In this case, the centrifugal force of the optical disc 1 is rapidly increased, and even when the optical disc 1 is moved in a direction perpendicular to the rotation shaft 150 of the spindle motor 300, the conic inner circumferential surface of the slide cone 260 closely contacts a cylindrical outer circumferential surface that forms a shaft support of the turntable 230 so that the optical disc 1 may be prevented from being moved in the direction perpendicular to the rotation shaft 150 of the spindle motor 300.

The present invention includes a spindle motor that uses an optical disc drive using a circular optical disc as an information storage medium and an information storage medium having various shapes including a hollow portion, and a rotational information storage device at which or from which the information storage medium is installed or detached.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, in the spindle motor according to the present invention, the center of an optical disc does not deviate from the rotational center of the spindle motor even during high-speed rotation but is identical therewith so that, in an optical disc drive rotating at high speed, errors that may occur in writing or reading data in or from the optical disc can be reduced and the optical disc can be easily replaced with a new one.

Furthermore, when the spindle motor starts rotating, a robust rotational force may exert by using friction between a rubber plate and a storage medium so that sliding during rotation can be prevented.

Furthermore, an additional elastic member that pushes a slide cone is not disposed, and due to an attractive force between a yoke and a cone yoke that is a magnet or an attractive force between the cone yoke that is formed of a magnetic material and a clamp magnet, the slide cone is moved upwards so that a thinner and smaller spindle motor can be provided and productivity and assembling characteristics of the spindle motor can be improved.

Furthermore, the spindle motor including a smaller rotor portion can be employed in the optical disc drive.

Although a few embodiments of the present invention have been shown and described, it would be appreciated by those skilled in the art that changes may be made in this embodiment without departing from the principles and spirit of the invention, the scope of which is defined in the claims and their equivalents.

1. A spindle motor at which or from which an information storage medium having a central opening portion is installed or detached, for rotating the information storage medium, the spindle motor comprising:
a rotation shaft;
a slide cone of a substantially cup-like shape comprising a cone cylindrical portion of a substantially cylindrical shape having an outer circumferential surface that may contact an inner circumferential portion of the central opening portion of the information storage medium,
a cone bottom portion in which the rotation shaft is inserted so that the cone is movable in an axial direction with respect to the rotation shaft, and a hollow portion formed upwards by the cone cylindrical portion and the cone bottom portion;
a turntable of a substantially hat-like shape comprising a turntable cylindrical portion of a substantially cylindrical shape having a top surface extended outward of the turntable cylindrical portion making contact with a bottom surface of the information storage medium,
a turntable bottom portion in which the rotation shaft is inserted so that the spindle motor rotates along with the rotation shaft, and a hollow portion in which, when the slide cone goes down in an axial direction, the slide cone is accommodated by the turntable cylindrical portion and the turntable bottom portion;
a yoke fixed at upper portions of the rotation shaft that protrudes from the slide cone within the hollow portion of the slide cone;
a clamp magnet disposed on the yoke; and
a cone yoke fixed at the cone bottom portion so that the cone yoke makes an axial motion in a direction below the yoke together with the slide cone and formed of a magnetic material.

2. The spindle motor of claim 1, wherein the cone yoke is fixed at a top surface of a bottom portion of the slide cone.

3. The spindle motor of claim 2, wherein the cone yoke is a permanent magnet.

4. The spindle motor of claim 1, wherein the cone yoke is fixed at a bottom surface of the bottom portion of the slide cone.

5. The spindle motor of claim 4, wherein the cone yoke is a permanent magnet.

6. The spindle motor of claim 1, further comprising a rubber plate that is substantially attached to the top surface of the turntable cylindrical portion so that, when the information storage medium is mounted on the spindle motor, the bottom surface of the information storage medium directly contacts the rubber plate.

7. The spindle motor of claim 6, further comprising:
a rotor magnet; and
a rotor case rotating along with the rotation shaft and comprising a cylindrical portion at which the rotor magnet is installed, wherein an outer circumferential surface of the cylindrical portion of the rotor case is placed in an inner position than a position of a cylindrical outer circumferential surface of the top surface of the turntable cylindrical portion in a radial direction.

8. An information storage device comprising:
the spindle motor of claim 7;
a pickup unit comprising an information writing portion for writing information in an information storage medium and an information reading portion for sensing the information from the information storage medium;
a controller controlling a motion of the pickup unit; and
a signal converter converting a signal transmitted from the pickup unit into a predetermined signal.

9. The spindle motor of claim 6, wherein the cone yoke is fixed at a top surface of a bottom portion of the slide cone.

10. The spindle motor of claim 9, wherein the cone yoke is a permanent magnet.

11. The spindle motor of claim 6, wherein the cone yoke is fixed at a bottom surface of the bottom portion of the slide cone.

12. The spindle motor of claim 11, wherein the cone yoke is a permanent magnet.

13. The spindle motor of claim 9, further comprising:
a rotor magnet; and
a rotor case rotating along with the rotation shaft and comprising a cylindrical portion at which the rotor magnet is installed, wherein an outer circumferential surface of the cylindrical portion of the rotor case is placed in an inner position than a position of a cylindrical outer circumferential surface of the top surface of the turntable cylindrical portion in a radial direction.

14. The spindle motor of claim 10, further comprising:
a rotor magnet; and
a rotor case rotating along with the rotation shaft and comprising a cylindrical portion at which the rotor magnet is installed, wherein an outer circumferential surface of the cylindrical portion of the rotor case is placed in an inner position than a position of a cylindrical outer circumferential surface of the top surface of the turntable cylindrical portion in a radial direction.

15. The spindle motor of claim 11, further comprising:
a rotor magnet; and
a rotor case rotating along with the rotation shaft and comprising a cylindrical portion at which the rotor magnet is installed, wherein an outer circumferential surface of the cylindrical portion of the rotor case is placed in an inner position than a position of a cylindrical outer circumferential surface of the top surface of the turntable cylindrical portion in a radial direction.

16. The spindle motor of claim 12, further comprising:
a rotor magnet; and
a rotor case rotating along with the rotation shaft and comprising a cylindrical portion at which the rotor magnet is installed, wherein an outer circumferential surface of the cylindrical portion of the rotor case is placed in an inner position than a position of a cylindrical outer circumferential surface of the top surface of the turntable cylindrical portion in a radial direction.
